(19) United States
(12) Patent Application Publication
(10) Pub. No.: US 2024/0427051 A1
(43) Pub. Date: Dec. 26, 2024

(54) METHOD AND APPARATUS TO IDENTIFICATION OF FEATURES IN A CARBONATE RESERVOIR WITH HIGH RESISTIVITY FROM HIGH RESOLUTION OIL-BASED MUD IMAGES

(71) Applicant: Schlumberger Technology Corporation, Sugar Land, TX (US)

(72) Inventor: Shiduo Yang, Clamart (FR)

(21) Appl. No.: 18/748,142

(22) Filed: Jun. 20, 2024

Related U.S. Application Data
(60) Provisional application No. 63/509,840, filed on Jun. 23, 2023.

(51) Int. Cl. G01V 3/38; G01V 3/28; G06V 10/24; G06V 10/44; G06V 10/50; G06V 10/764; G06V 20/10

(52) U.S. Cl. CPC G01V 3/38; G01V 3/28; G06V 10/242; G06V 10/443; G06V 10/50; G06V 10/764; G06V 20/10

(57) ABSTRACT

Embodiments presented provide for a method for identification of defects in geological stratum, called vugs. The identification of the vugs is performed on data from high resolution oil-based mud images obtained from wireline and/or drilling activities.

### CROSS-REFERENCE TO RELATED APPLICATIONS

This application claims priority to and the benefit of U.S. Provisional Patent Application No. 63/509,840, entitled “Method and Apparatus to Identification of Features in a Carbonate Reservoir with High Resistivity from High Resolution Oil-Based Mud Images,” filed Jun. 23, 2023, the entire disclosure of which is hereby incorporated herein by reference.

### FIELD OF THE DISCLOSURE

Aspects of the disclosure relate to identification of features in a carbonate reservoir. More specifically, aspects of the disclosure relate to identification of vug features in a carbonate reservoir that has high resistivity based on high resolution oil-based mud images.

### BACKGROUND

Vug features are important for carbonate reservoir characterization. Vug features are defects in a geological stratum. These defects may be, for example, a crack, a void, or other type of space. These voids may contain fluids or may be empty. Vugs are often found in many types of geological stratum. In order to determine the presence of vugs, a borehole image may be obtained by operators. Borehole image data is one of the fundamental data sources for the vug features analysis beside expensive core data. In water-based mud environments, there are conventional algorithms for the vug feature identification. A surface density evaluation may be performed from resistivity image data. To date; however, there is no available workflow or method for vug analysis from resistivity image in oil-based mud environment data. Although ultrasonic images can be used for vug analysis in oil-based mud environment, the image quality is significantly influenced by mud solid materials. Lower logging speeds used to obtain such images is also a main factor for the application in the offshore rigs with oil-based mud.

True formation resistivity is very difficult to be measured in oil-based mud environments. Often times, a multiple array induction tool is attempted to be used to obtain the resistivity values. The high-resolution induction tool can provide the detailed geological texture features, but the resistivity measurements provide a relative resistivity contrast, not the true formation resistivity. Such relative resistivity values are achieved in the so called “flush zone” of a wellbore. This high-resolution oil-based mud (OBM) tool is a pad-based microelectrical imager operating at high frequency to establish capacitive contact with the formation in wellbores filled with non-conductive mud. From multiple modes of operation, formation resistivity-like images are generated using an efficient composite data-processing scheme that approximates formation resistivity either by filtering or applying a correction to minimize the contribution of the OBM to the measured signal. Data from the different modes are blended, based on estimated formation parameters, to generate an optimized image.

In addition to the composite processing scheme described above, a model-based parametric inversion was also developed for quantitative interpretation. The Gauss-Newton algorithm matches the measurements to an accurate, computationally efficient, approximate forward model built by multidimensional fitting of the data generated using a finite-element simulation. The conventional workflow overcomes the underdetermined inversion problem and calibration limitations of the measurements. The inversion allows flexible model definition and parameterization, including refinement of the calibration, and can process intervals of logging data and measurements from multiple sources simultaneously. The conventional workflow stabilizes the inversion and improves the consistency of the processed results.

The vug features response on resistivity images in oil-based mud environment is very complex comparing the constant conductive features of resistivity image in water-based mud environment. Depending on the resistivity contrast between formation resistivity in the flush zone and mud or mud filter, the vug features could be based upon resistivity or conductivity. A Hayman factor image was applied to vug features classification; however, the absolute values of the Hayman factor image could be presenting the mud or mud filter in the vug. The local contrast is very useful for the vug feature identification, but vug features can be high or low contrast value of the Hayman factor image depending on the vug size and surrounding rock matrix. The inverted standoff image represents the borehole rugosity and the relatively low or high standoff could be indicating the vug features. When the size of vug features is large enough, the vug is commonly filled with mud filter and is represented as low standoff features. There is no efficient way to identify vug features only based on the image response. Moreover, the depth of investigation of the image tool is very shallow. The image measurement may be influenced by the mud cake thickness as well.

There is a need to provide an apparatus and methods that are easier to operate than conventional apparatus and methods to identify vug features based upon oil-based mud images.

There is a further need to provide apparatus and methods that do not have the drawbacks discussed above, namely, inability to determine vug presence in certain wells.

There is a still further need to reduce economic costs associated with operations and apparatus described above with conventional tools and to allow operations personnel to cost effectively determine vug presence in carbonate reservoirs.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for identification of features in a carbonate reservoir is disclosed. The method may comprise obtaining an induction resistivity log from a wellbore within the carbonate reservoir. The method may also comprise obtaining inverted resistivity image data. The method may also comprise obtaining inverted standoff image data. The method may also comprise obtaining inverted Hayman factor image data. The method may also comprise calculating an image average resistivity computation from the inverted resistivity image data. The method may also comprise performing a resistivity zonation for the wellbore from the induction resistivity log and the average resistivity computation. The method may also comprise performing an extraction of patches based upon the inverted resistivity image data. The method may also comprise performing an image local histogram equalization from inverted standoff and Hayman factor images. The method may also comprise performing high and lower patches from localized dynamic standoff and Hayman factor images. The method may also comprise classifying the patches for vug features based upon the extraction and the resistivity zonation. The method may also comprise performing a surface density calculation.

In another example embodiment, a method for identification of features in a carbonate reservoir is described. The method may comprise obtaining an induction resistivity log from a wellbore within the carbonate reservoir. The method may further comprise obtaining inverted resistivity image data. The method may further comprise obtaining inverted standoff image data. The method may further comprise obtaining inverted Hayman factor image data. The method may further comprise calculating an image average resistivity computation from the inverted resistivity image data. The method may further comprise performing a resistivity zonation for the wellbore from the induction resistivity log and the average resistivity computation, wherein the resistivity zonation includes four different zones. The method may further comprise performing an extraction of patches based upon the inverted resistivity image data. The method may further comprise performing an image local histogram equalization from inverted standoff and Hayman factor images. The method may further comprise performing high and lower patches from localized dynamic standoff and Hayman factor images. The method may further comprise classifying the patches for vug features based upon the extraction and the resistivity zonation. The method may further comprise filtering the vug features and performing a surface density calculation.

In another example embodiment, an article of manufacture comprised to store a set of instructions to run on a computer, the article of manufacture configured to store the set of instructions in a non-volatile manner is disclosed. The instruction contained on the article of manufacture may comprise obtaining an induction resistivity log from a wellbore within the carbonate reservoir. The instruction contained on the article of manufacture may further comprise obtaining inverted resistivity image data. The instruction contained on the article of manufacture may further comprise obtaining inverted standoff image data. The instruction contained on the article of manufacture may further comprise obtaining inverted Hayman factor image data. The instruction contained on the article of manufacture may further comprise calculating an image average resistivity computation from the inverted resistivity image data. The instruction contained on the article of manufacture may further comprise performing a resistivity zonation for the wellbore from the induction resistivity log and the average resistivity computation. The instruction contained on the article of manufacture may further comprise performing an extraction of patches based upon the inverted resistivity image data. The instruction contained on the article of manufacture may further comprise performing an image local histogram equalization from inverted standoff and Hayman factor images. The instruction contained on the article of manufacture may further comprise performing high and lower patches from localized dynamic standoff and Hayman factor images. The instruction contained on the article of manufacture may further comprise classifying the patches for vug features based upon the extraction and the resistivity zonation. The instruction contained on the article of manufacture may further comprise filtering the vug features. The instruction contained on the article of manufacture may further comprise performing a surface density calculation based on the vug filtering.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is method for analysis of oil-based mud resolution images in one example embodiment of the disclosure.

FIG. 2 is a graph of high and low value patches of local histogram equalization processed on the inverted standoff and Hayman factor images.

FIG. 3 is a graph of heterogeneity features on a dynamic image and extracted patches in a high resistivity zone.

FIG. 4 is a graph of heterogeneity features on images in a low resistivity zone with larger resistivity difference.

FIG. 5 is a graph of heterogeneity features on images in a low resistivity zone with smaller resistivity difference.

FIG. 6 is a graph of heterogeneity features on images in a middle resistivity zone.

FIG. 7 is a graph of classified and filtered images and vug density comparison.

FIG. 8 is a graph of overlaid vug images for resistivity thresholds estimation.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

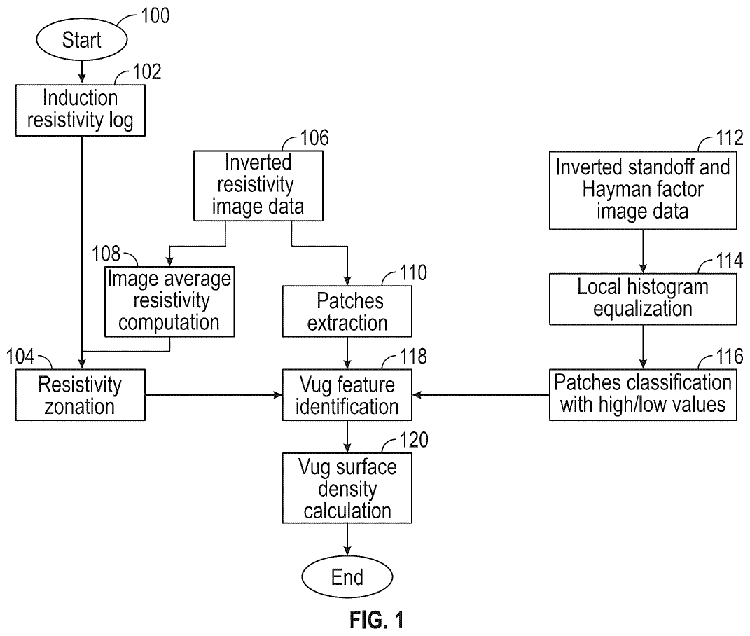

Referring to FIG. 1 one aspect of the disclosure is illustrated, wherein an integrated method 100 for identification of vug from OBM high-resolution images is presented. In embodiments, although an inversed resistivity image provided the more accurate resistivity image for a wellbore, the absolute image values are not true formation resistivity in the image measurement depth scope. As these images do not provide a true formation resistivity, there is a need to provide such a value. In embodiments; moreover, the mud or mud filter, at downhole conditions, are not calculated from two megahertz measurements. The external induction resistivity log is integrated to identify the relationship between formation resistivity and mud filter resistivity. The inverted standoff and Hayman factor image have a complex response on the vug features and are embedded in the workflow for the vug feature identification and filtering. The conductive vug texture feature extraction from a water-based mud image or low amplitude vug feature was reused and applied on the conductive & resistive patches extraction from an oil-based mud image.

Referring to FIG. 1, a method 100 for feature identification in carbonate reservoirs with high resistivity from high resolution oil-based mud images is illustrated. In the method, data pertaining to an induction resistivity log is obtained at 102. In addition to the data obtained at 102, inverted resistivity image data is obtained at 106. The induction resistivity log 102 may be obtained from a resistivity tool placed within the wellbore during a wireline operation or may be obtained during the drilling process. In a similar fashion, the inverted resistivity image data may be obtained during a wireline operation or may be obtained during the drilling process. Proceeding from the induction resistivity log data at 102, a process of resistivity zonation 104 occurs. In such a process, resistivity for the wellbore is broken up into discrete zones. The size and shape of the discrete zones may vary. Proceeding from obtaining the inverted resistivity image data at 106, the data may be used to compute an image-average resistivity at 108, which then proceeds to the resistivity zonation at 104, previously described. The inverted resistivity image data at 106 may also be used to calculate patches that may be extracted at 110. Proceeding from obtaining the inverted standoff and Hayman factor images data at 112, the data may be used to generate a dynamic image with local histogram equalization processing at 114. From this dynamic image, the patches with high or low values may be extracted at 116. Following the extraction at 110, the method proceeds to identification for vug features at 118 from both 104, 110 and 116. Following the vug identified at 118, a vug density calculation may be performed at 120.

In the method 100, preprocessing may be accomplished. Such preprocessing may be creating full-bore image construction for oil-based mud and water-based mud types.

In the method 100, at 108, the average resistivity log is computed from inverted resistivity image at each single depth and smoothed with a sampling rate that is consistent with induction resistivity log. At 118, the process of analyzing and identifying patches may include evaluating which values would be a high value patch and which value would be a low value patch.

In this section, classification and filtering of vug features from identified patches which extracted from high resolution OBM image is disclosed. In embodiments, the method 100 is suitable for carbonate reservoir. As will be understood, the method 100 may be used in reservoirs that have different formation resistivities.

At 114, image local histogram equalization is performed on inverted standoff and Hayman factor images. The local contrast of images is used for vug features' classification from Hayman factor image and standoff image. The adaptive histogram equalization (AHE) is selected for image local histogram equalization on Hayman factor image and standoff image. Adaptive histogram equalization (AHE) improves the scattered distribution of pixel values by transforming each pixel with a transformation function derived from a neighborhood region. Thus, the transformation function for each region can be different. It is therefore suitable for improving the local contrast and enhancing the definitions of edges in each region of an image. However, when there are small amounts of noise in a largely homogeneous region, the transformation function will be greatly affected by the noise. Therefore, the Gaussian smoothing was applied to remove the noise before applying AHE.

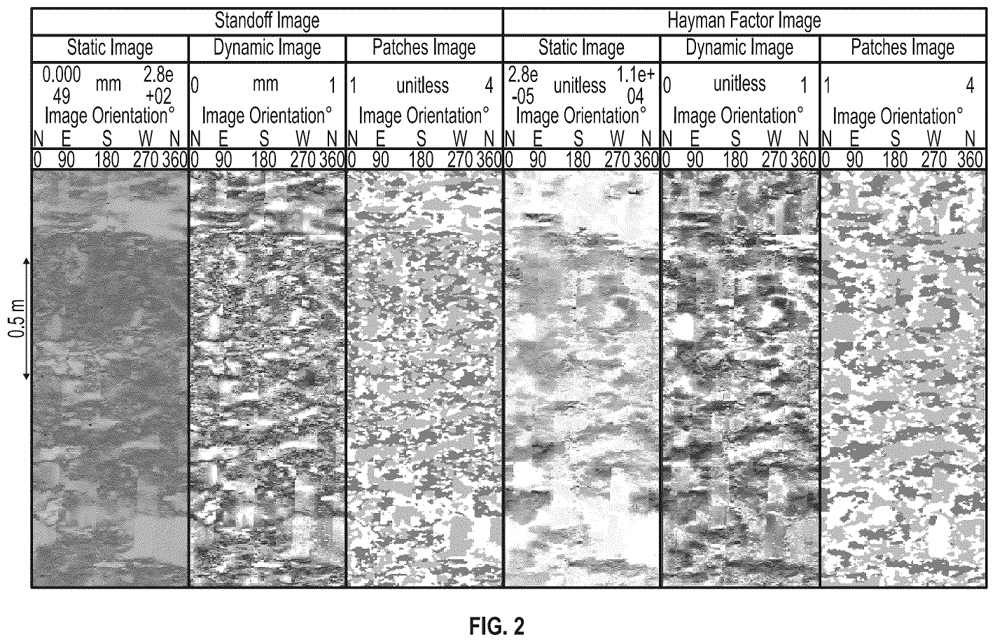

Referring to FIG. 2, the patches with high and low values are extracted from processed dynamic images for standoff and Hayman factor image separately. The vug features have a complex response on standoff and Hayman factor images.

At 104, resistivity zonation is performed. As a true formation resistivity can not be computed or measured from induction resistivity tool directly; and the resistivity in the flush zone can not be measured and calculated from induction resistivity tool and high-resolution resistivity image tool as well, resistivity zonation is accomplished. There are four (4) different resistivity zonations classified based on the difference between induction resistivity logs and image-based averaged resistivity (as indicated below):

$$Flag = \{ \begin{matrix}0 , & {R}_{I} > {R}_{th \_ h} \\ 1 , & {R}_{I} < {R}_{th \_ h} , {R}_{I} < {R}_{th \_ l} and {R}_{m} - {R}_{I} > {R}_{th \_ dif} \\ 2 , & {R}_{I} < {R}_{{th}_{h}} , {R}_{I} < {R}_{th \_ l} and {R}_{m} - {R}_{I} < {R}_{th \_ dif} \\ 3 , & {R}_{I} < {R}_{th \_ h} , {R}_{I} > {R}_{{th}_{l}}\end{matrix}$$

where Rₗ is induction resistivity. Rₘ is the image-averaged based resistivity. R_{th_h} is the high resistivity threshold, normally the value is setting as 2000 ohm·m limited by tool measurement limitation. R_{th_l} is the low resistivity threshold, and commonly same as mud resistivity estimated from high frequency of image. R_{th_dif} is the resistivity difference threshold between induction resistivity log and image-based average resistivity at same depth.

At 112, patch classification for vug features is performed. For vug classification in different resistivity zones, both resistive and conductive patches are extracted. It should be noted; however, that not all of the resistive and conductive patches are vug features. In a very high resistivity zone, the conductive/resistive patches are extracted based on the contrast. These patches are only visible on the dynamic image and more representative of the texture heterogeneity, not vug features, although the conductive/resistive patches are extracted from an image.

Example embodiments are described regarding FIGS. 2 through 7. As will be understood, such embodiments should not be considered limiting. Different zonations, namely flag conditions 1, 2 and 3, described above, are illustrated in relation to FIGS. 2 through 4.

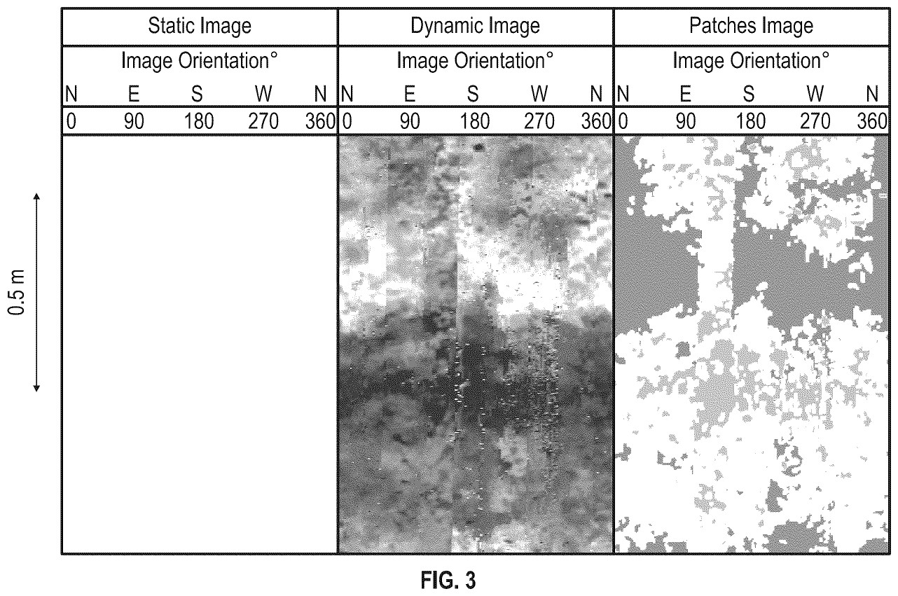

Referring to FIG. 3, heterogeneity features on dynamic images and extracted patches in high resistivity zones are depicted. In the very high resistivity zone, the conductive/resistive patches are still extracted based on the contrast. But these patches are only visible on the dynamic image and more representing the texture heterogeneity, not vug features although the conductive/resistive patches are extracted from image

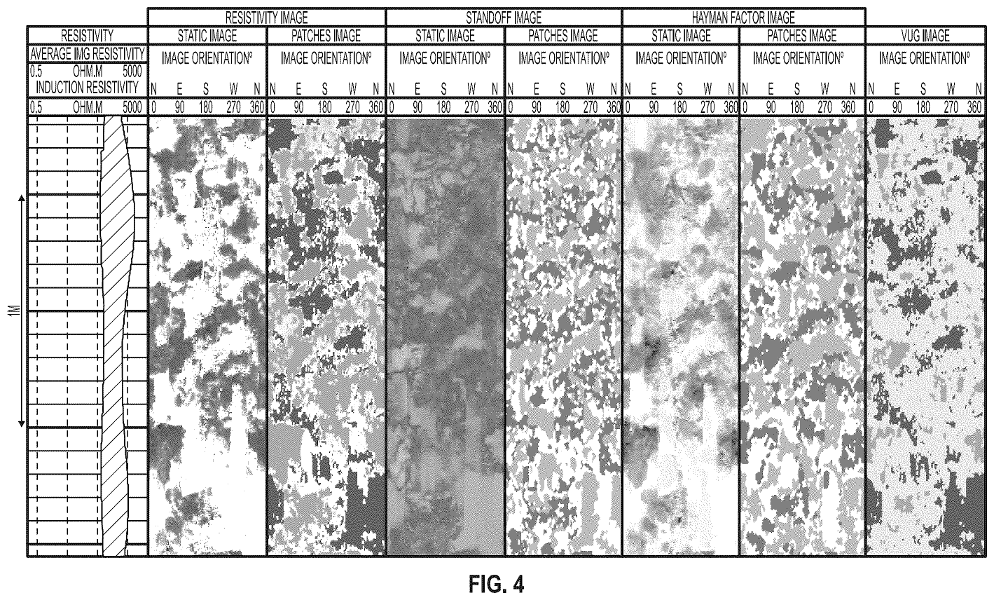

Referring to FIG. 4, heterogeneity features on images in low resistivity zone with larger resistivity difference. In the flag 1 zonation, the formation resistivity is relatively low from the induction resistivity log, but the image-based resistivity is higher than the induction resistivity log. While both conductive/resistive patches are extractable from resistivity images, only larger resistive patches are representing the vug features, the smaller conductive patches can be vug feature as well. The classification rules are followings: (1) The resistivity patches extracted from inverted resistivity image are vug features when the patches of standoff image are relatively lower values, and the patches of Hayman factor image are relatively with lower values. (2) The conductive patches extracted from inverted resistivity image are vug features patches of standoff image are relatively lower values, and the patches of Hayman factor image are relatively with higher values. The reason for higher image-based resistivity is that mud resistivity is higher than formation resistivity, and the vug is filled with oil-based mud or mud cake in the vugs, the standoff value is relatively lower and the Hayman factor value of mud is lower than surrounding rock matrix. The small conductive patches are representing filled mud as well, but the higher Hayman factor is caused by the lower resistivity influenced by the water component in the mud.

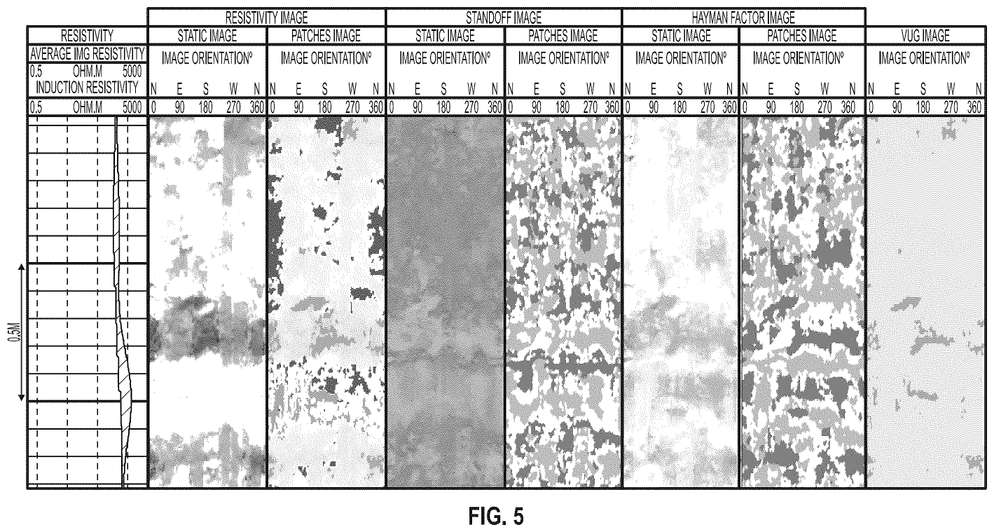

Referring to FIG. 5, heterogeneity features on images in a low resistivity zone with smaller resistivity differences are illustrated. In the flag 2 zonation, the formation resistivity is relatively lower from the induction resistivity log, and the image-based resistivity is also higher than the induction resistivity log; but the resistivity differences are smaller compared to the flag 1 zone. Both conductive/resistive patches are extractable from resistivity image, only small conductive patches are representing the vug features. In such intervals, the mud resistivity is smaller than formation resistivity; the vug is filled with oil-based mud or mud cake. The higher image-based resistivity was caused by the different tool measurement principle.

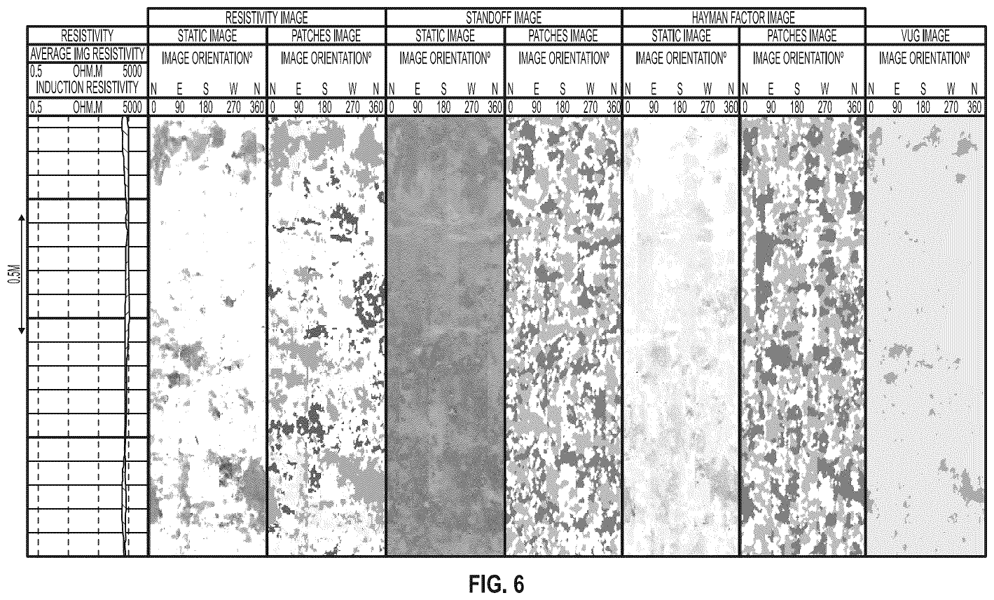

Referring to FIG. 6, heterogeneity features on images with a middle resistivity range is illustrated. For example, in the flag 3 zonation, the formation resistivity is between the low and high threshold, and the image-based resistivity could be higher or smaller than the induction resistivity log. The resistivity difference is smaller in most cases. Both conductive/resistive patches are extractable from a resistivity image, only small conductive patches are representing the vug features.

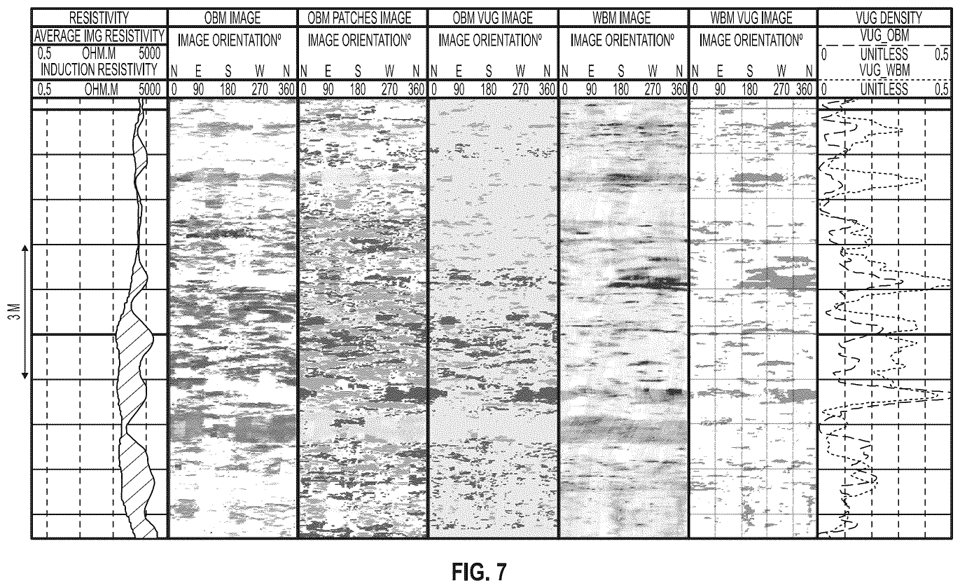

Referring to FIG. 7, classified and filtered vug images are illustrated. Vug features validation with a water-based mud image in the same well are performed. The vug features were validated with a heterogeneity analysis result from the water-based mud image at the same well. The vug surface density log was computed with a same window size. The vug density log was almost at the same scale in most intervals. There could be a larger difference at breakout or formation damage intervals of water-based mud images because these two images were logged at different times.

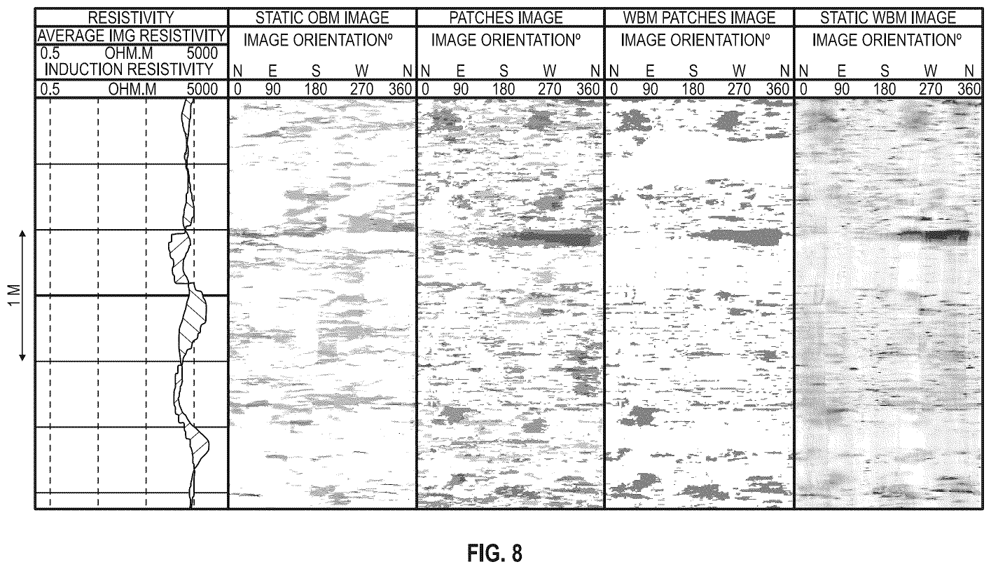

Referring to FIG. 8, overlaid vug images for resistivity thresholds estimation are illustrated. Threshold estimations based on the patches extracted from resistivity images in water-based mud or ultrasonic images in oil-based mud in the same well are shown. The confirmed vug features were extracted from a water-based mud resistivity image or oil-based mud ultrasonic image. The patches extracted from oil-based mud are labeled as vug features if the patch area is overlaid with patches from water-based mud images or ultrasonic images. The chosen input data (vug size, induction resistivity, and image-based average resistivity) were extracted at the same depth. The resistivity thresholds are computed from the statistics results accordingly.

Example embodiments of the claims are presented. The embodiments should not be considered limiting. In one example embodiment, a method for identification of features in a carbonate reservoir is disclosed. The method may comprise obtaining an induction resistivity log from a wellbore within the carbonate reservoir. The method may also comprise obtaining inverted resistivity image data. The method may also comprise obtaining inverted standoff image data. The method may also comprise obtaining inverted Hayman factor image data. The method may also comprise calculating an image average resistivity computation from the inverted resistivity image data. The method may also comprise performing a resistivity zonation for the wellbore from the induction resistivity log and the average resistivity computation. The method may also comprise performing an extraction of patches based upon the inverted resistivity image data. The method may also comprise performing an image local histogram equalization from inverted standoff and Hayman factor images. The method may also comprise performing high and lower patches from localized dynamic standoff and Hayman factor images. The method may also comprise classifying the patches for vug features based upon the extraction and the resistivity zonation. The method may also comprise performing a surface density calculation.

In another example embodiment, the method may be performed wherein the carbonate reservoir has a varied resistivity scope.

In another example embodiment, the method may be performed wherein the filtering the vug features is performed based on relatively higher or lower values of standoff and Hayman factor images.

In another example embodiment, the method may be performed wherein the patches are based upon at least one of conductivity and resistivity.

In another example embodiment, a method for identification of features in a carbonate reservoir is described. The method may comprise obtaining an induction resistivity log from a wellbore within the carbonate reservoir. The method may further comprise obtaining inverted resistivity image data. The method may further comprise obtaining inverted standoff image data. The method may further comprise obtaining inverted Hayman factor image data. The method may further comprise calculating an image average resistivity computation from the inverted resistivity image data. The method may further comprise performing a resistivity zonation for the wellbore from the induction resistivity log and the average resistivity computation, wherein the resistivity zonation includes four different zones. The method may further comprise performing an extraction of patches based upon the inverted resistivity image data. The method may further comprise performing an image local histogram equalization from inverted standoff and Hayman factor images. The method may further comprise performing high and lower patches from localized dynamic standoff and Hayman factor images. The method may further comprise classifying the patches for vug features based upon the extraction and the resistivity zonation. The method may further comprise filtering the vug features and performing a surface density calculation.

In another example embodiment, the method may be performed wherein each of four different zones are classified as 0, where Rₗ>R_{th_h}, as 1 where Rₗ<R_{th_h}, Rₗ<R_{th_l} and Rₘ-Rₗ>Rₜₕ_{_{dif}}, as 2 where Rₗ<Rₜₕ_{ₕ}, Rₗ<R_{th_l} and Rₘ-Rₗ<R_{th_dif}, and as 3 where Rₗ<R_{th_h}, Rₗ>Rₜₕ_{ₗ} where Rₗ is induction resistivity, Rₘ is an image-based averaged resistivity, R_{th_h} is a high resistivity threshold, R_{th_l} is a low resistivity threshold and R_{th_dif} is a resistivity difference threshold.

In another example embodiment, the method may be performed wherein the carbonate reservoir has a varied resistivity scope.

In another example embodiment, the method may be performed wherein the filtering the vug features is performed based on relatively higher or lower values of standoff and Hayman factor images.

In another example embodiment, the method may be performed wherein the patches are based upon at least one of conductivity and resistivity.

In another example embodiment, an article of manufacture comprised to store a set of instructions to run on a computer, the article of manufacture configured to store the set of instructions in a non-volatile manner is disclosed. The instruction contained on the article of manufacture may comprise obtaining an induction resistivity log from a wellbore within the carbonate reservoir. The instruction contained on the article of manufacture may further comprise obtaining inverted resistivity image data. The instruction contained on the article of manufacture may further comprise obtaining inverted standoff image data. The instruction contained on the article of manufacture may further comprise obtaining inverted Hayman factor image data. The instruction contained on the article of manufacture may further comprise calculating an image average resistivity computation from the inverted resistivity image data. The instruction contained on the article of manufacture may further comprise performing a resistivity zonation for the wellbore from the induction resistivity log and the average resistivity computation. The instruction contained on the article of manufacture may further comprise performing an extraction of patches based upon the inverted resistivity image data. The instruction contained on the article of manufacture may further comprise performing an image local histogram equalization from inverted standoff and Hayman factor images. The instruction contained on the article of manufacture may further comprise performing high and lower patches from localized dynamic standoff and Hayman factor images. The instruction contained on the article of manufacture may further comprise classifying the patches for vug features based upon the extraction and the resistivity zonation. The instruction contained on the article of manufacture may further comprise filtering the vug features. The instruction contained on the article of manufacture may further comprise performing a surface density calculation based on the vug filtering.

In another example the article of manufacture may be configured such that the method contained in the article of manufacture is performed on the carbonate reservoir having a varied resistivity scope.

In another example the article of manufacture may be configured such that the method contained in the article of manufacture is performed wherein the patches are based upon at least one of conductivity and resistivity.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for identification of features in a carbonate reservoir, comprising:
obtaining an induction resistivity log from a wellbore within the carbonate reservoir;
obtaining inverted resistivity image data;
obtaining inverted standoff image data;
obtaining inverted Hayman factor image data;
calculating an image average resistivity computation from the inverted resistivity image data;
performing a resistivity zonation for the wellbore from the induction resistivity log and the average resistivity computation;
performing an extraction of patches based upon the inverted resistivity image data;
performing an image local histogram equalization from inverted standoff and Hayman factor images;
performing high and lower patches from localized dynamic standoff and Hayman factor images;
classifying the patches for vug features based upon the extraction and the resistivity zonation; and
performing a surface density calculation.

2. The method according to claim 1, wherein the carbonate reservoir has a varied resistivity scope.

3. The method according to claim 1, wherein the filtering the vug features is performed based on higher or lower values of standoff and Hayman factor image data.

4. The method according to claim 1, wherein the patches are based upon at least one of conductivity and resistivity.

5. A method for identification of features in a carbonate reservoir, comprising:
obtaining an induction resistivity log from a wellbore within the carbonate reservoir;
obtaining inverted resistivity image data;
obtaining inverted standoff image data;
obtaining inverted Hayman factor image data;
calculating an image average resistivity computation from the inverted resistivity image data;
performing a resistivity zonation for the wellbore from the induction resistivity log and the average resistivity computation, wherein the resistivity zonation includes four different zones;
performing an extraction of patches based upon the inverted resistivity image data;
performing an image local histogram equalization from inverted standoff and Hayman factor images;
performing high and lower patches from localized dynamic standoff and Hayman factor images;
classifying the patches for vug features based upon the extraction and the resistivity zonation;
filtering the vug features; and
performing a surface density calculation.

6. The method according to claim 5, wherein each of four different zones are classified as 0, where Rₗ>R_{th_h}, as 1 where Rₗ<R_{th_h}, Rₗ<R_{th_l} and Rₘ-Rₗ>Rₜₕ_{_{dif}}, as 2 where Rₗ<Rₜₕ_{ₕ}, Rₗ<R_{th_l} and Rₘ-Rₗ<R_{th_dif}, and as 3 where Rₗ<R_{th_h}, Rₗ>Rₜₕ_{ₗ}
where Rₗ is induction resistivity. Rₘ is an image-based averaged resistivity, R_{th_h} is a high resistivity threshold, R_{th_l} is a low resistivity threshold and R_{th_dif} is a resistivity difference threshold.

7. The method according to claim 5, wherein the carbonate reservoir has a varied resistivity scope.

8. The method according to claim 5, wherein the filtering the vug features is performed based on high or low value of patches extracted from inverted standoff and Hayman factor image.

9. The method according to claim 5, wherein the patches are based upon at least one of conductivity and resistivity.

10. An article of manufacture comprised to store a set of instructions to run on a computer, the article of manufacture configured to store the set of instructions in a non-volatile manner, the instructions stored, comprising:
obtaining an induction resistivity log from a wellbore within the carbonate reservoir;
obtaining inverted resistivity image data;
obtaining inverted standoff image data;
obtaining inverted Hayman factor image data;
calculating an image average resistivity computation from the inverted resistivity image data;
performing a resistivity zonation for the wellbore from the induction resistivity log and the average resistivity computation;
performing an extraction of patches based upon the inverted resistivity image data;
performing an image local histogram equalization from inverted standoff and Hayman factor images;
performing high and lower patches from localized dynamic standoff and Hayman factor images;
classifying the patches for vug features based upon the extraction and the resistivity zonation;
filtering the vug features; and
performing a surface density calculation based on the vug filtering.

11. The article of manufacture according to claim 10, wherein the method contained in the article of manufacture that is performed on the carbonate reservoir has a varied resistivity scope.

12. The article of manufacture according to claim 10, wherein the method contained in the article of manufacture is performed such that the filtering of the vug features is based on the high or low values of standoff and Hayman factor image data.

13. The article of manufacture according to claim 10, wherein the method contained in the article of manufacture is performed wherein the patches are based upon at least one of conductivity and resistivity.
